(19) United States
(12) Patent Application Publication
(10) Pub. No.: US 2005/0232699 A1
(43) Pub. Date: Oct. 20, 2005

(54) Aquatic weed suppressor

(76) Inventor: Warren J. Grosjean, Wayne, NJ (US)

Correspondence Address: WARREN J. GROSJEAN, 32 JUNIPER RD., WAYNE, NJ, 07470-6156, US

(21) Appl. No.: 10/825,166

(22) Filed: Apr. 16, 2004

(51) Int. Cl. E02B 3/06; A01N 55/02

(52) U.S. Cl. 405/24; 405/21

(57) ABSTRACT

A sub surface aquatic weed barrier consisting of a strip of plastic held to the aquatic substrate by transverse weights bonded to the plastic strip. Gas release ports are located in the plastic sheet, positioned midway between the transverse weights.

### CROSS REFERENCE TO RELATED APPLICATIONS

Not applicable.

### STATEMENT REGARDING FEDERALLY SPONSORED RESEARCH

There was no Federal support for this research or development.

### BACKGROUND

1. Field of Invention

This invention is in the field of the suppression of sub-surface aquatic weed growth.

2. Description of Prior Art

Some relative patents:

| | | | |
|---|---|---|---|
| 4056936 | November 1977 | Mayer | 405/302.7 |
| 4518280 | May 1985 | Fletcher | 405/17 |
| 4577996 | March 1986 | Elias, Fletcher | 405/17 |

The problem with weed infestation in relatively shallow (eight feet or less) bodies of water whether they be ponds, lakes, canals, irrigation ditches, or tidal areas has been increasingly obvious. (See: Michigan State University manual E-2437 issued 12/98 titled “Aquatic Pest Management” with particular reference to Chapter 6. Another relative article can be found at “www.Army.mil/el/aqua/apis/mechanical/eurasian.html). The condition is evident in almost any aquatic environment where there is relatively slow movement of the water. Aquatic weed growth has a deleterious effect on aquatic activities and can be a health hazard. If permitted unchecked the ultimate result of aquatic weed growth is the transformation of the body of water into swamp and eventually into great farm land. The relatively recent introduction of Eurasian Milfoil into the US Northeast's aquatic ecosystem has been a disaster. Some idea of the costs relating to the control of aquatic weeds can be gleaned from a report of the projects funded by the State of Washington under their Aquatic Weeds Program for the period 1994 to 2000 found at site: “www.ecy.gov/programs/wq/plants/grants/projects.html”

A review of the literature indicates that many solutions have been proffered:
1) Mostly they involve the repeated use of chemical agents. The EPA's interest in these chemical treatments has tended to limit their use and effectiveness and the repeated applications are costly.
2) Another proffered solution is the mechanical removal by cutting or pulling out the objectionable weeds. The required continuous application of such procedures, their labor intensive nature, and the problems with the disposal of the removed material have limited the use of these techniques.
3) Yet another solution is the lowering of the body of water in the Fall of the year and trusting in mother nature to kill the weeds and their seeds. This requires a significant lowering of the water level through a period of deep freezing and has proven to be only a slight mitigator of the problem in the next season. Also most affected bodies of water can not be lowered adequately or there is not the potential for deep freezing. And, the most serious objection to this solution, the surviving weeds are generally the naiads and the Eurasian Milfoil—the major problems.
4) Another proffered solution is the covering of the soil below the water with a shield of some sort to stop the sun's rays from stimulating weed growth. The trick here is to keep the cover, usually a plastic film or screen, down on the ground below the water while permitting the gases resulting from decomposition to escape.
5) Another solution is the introduction of grass eating fish. The down sides here include the fact that these particular fish prefer other weeds than Eurasian Milfoil and therefore remove the desirable weeds before attacking the problem weeds and the need to feed the fish after the weeds are eaten.
6) The solution theoretically most acceptable is the deepening of the water to the point where inadequate sunlight gets to the aquatic substrate to foster the growth of weeds or when weeds grow they do not reach the surface of the water. In most instances this is not a practical solution.

After years of involvement in the aquatic weed problem as relates to fresh water lakes, I have finally identified a solution which is economical, easy to install and does the job. This is the subject of this disclosure.

### SUMMARY OF INVENTION

A means of blocking the sun's rays so that they do not stimulate aquatic plant growth by covering the substrate with an opaque film, said film being held to the substrate by heavier than water “bars” either integral with the film, attached to the film, or otherwise positioned on the film in a configuration that causes the gases of decomposition to migrate to sections of the film where there have been located gas release ports.

### DESCRIPTION OF THE DRAWINGS

FIG. 1 is a view of the aquatic weed suppressor in position on the bottom of a water body. It illustrates the effect of the buoyancy of the plastic where it forms a convex surface anchored by the lateral hold down means as well as some of the plethora of possible gas release port configurations.

FIG. 2 is a view of the aquatic weed suppressor in position on an irrigation ditch showing the hold down means.

### DESCRIPTION OF PREFERRED EMBODIMENTS

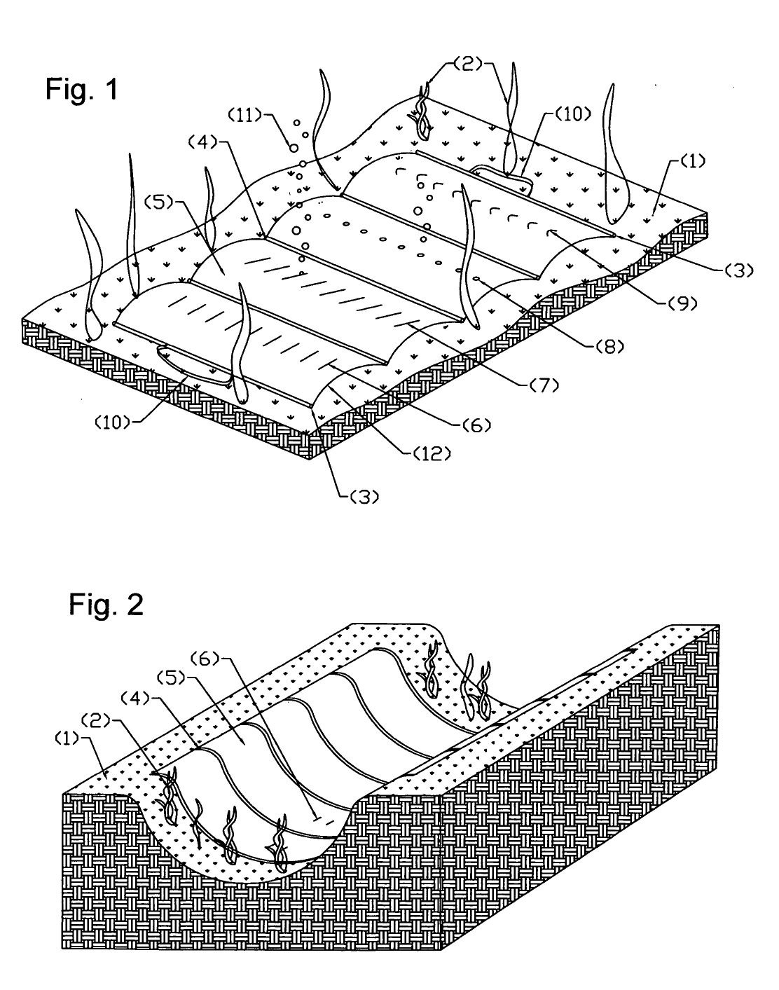

Bearing in mind that the intention is to provide a means for the suppression of the growth of aquatic weeds that is inexpensive, environmentally unobtrusive, and readily installed and maintained by a property owner, I am proposing the following as the preferred embodiment for the lake application (Refer to FIG. 1):

A sheet of polyethylene (5) of width approximately 12 feet and length approximately 40 feet has positioned laterally, about every 5 feet, weights (4) for the purpose of holding the plastic sheet to the bottom of the body of water. The weights are rebar encased in and attached to the plastic sheet with sand filled hot melt glue. The hot melt glue provides the attachment and the rebar and sand provide the weight. Midway between the laterally placed weights are slits cut in the plastic (6) spaced laterally about 2 feet apart. Attached to the end lateral weights (3) are rope handles (10) to facilitate installation and removal. The plastic sheet between the hold down means assumes a convex configuration (12) which directs the gasses of decomposition to the gas release ports (6).

This bethanic barrier is installed by positioning the plastic sheet (accordion pleated at assembly) on the stern of a row boat; the free end is pulled off by the rope handle and held while the boat is rowed away and the plastic sheet pulled into the water. When fully dispensed the barrier is pulled reasonably taught and released to settle to the bottom. Its removal is the reverse of the above. It is expected that the barrier will be removed or repositioned at least every growing season to minimize sediment accumulation problems. To cover large areas multiple barriers are positioned adjacent to each other.

For the irrigation and drainage ditch application (FIG. 2) the plastic sheet (5) would be of width adequate to bridge the ditch and of length limited by ease of application. The lateral hold down means (4) are either tubes attached to the plastic sheet filled with aggregate or sand filled hot melt glue attached to the plastic by the glue and spaced about 3 feet apart.

Note: While there has been disclosed effective and efficient embodiments of the invention, it should be well understood that the invention is not limited to such embodiments, as there are changes that can be made in the arrangement, form, materials and attachment means-without departing from the principle of the present invention as comprehended within the scope of the accompanying claim.

1. An aquatic weed suppression means comprising:
a strip of plastic of width five or more feet and having a specific gravity of one or less; and
a plurality of transverse hold down means, either integral with or attached to the strip of plastic, running substantially the entire width of the strip of plastic and spaced between one and five feet apart.

2. (canceled)

3. An aquatic weed suppression means in accordance with claim 1 wherein the plastic is polyethylene.

4. An aquatic weed suppression means in accordance with claim 1 wherein the plastic is a tough material capable of withstanding the abrasive action of active water and sharp rocks.

5. An aquatic weed suppression means in accordance with claim 1 wherein the plurality of hold down means are transversely attached tubes filled with any of a variety of heavier than water materials.

6. An aquatic weed suppression means in accordance with claim 1 wherein the plurality of hold down means are composed of sand filled hot melt glue.

7. An aquatic weed suppression means in accordance with claim 1, further comprising a plurality of gas release ports in the plastic strip located midway between the transverse hold down means, and spaced between one and four feet apart in the direction of the width of the plastic strip.

8. An aquatic weed suppression means in accordance with claim 7 wherein the gas release ports are slits or small holes.

9. An aquatic weed suppression means in accordance with claim 8 wherein the slits are about three inches long and positioned so as to be not substantially parallel to the width of the plastic strip.

10. A weed suppression means for use in irrigation and drainage ditches, comprising:
a strip of plastic of width adequate to span the ditch and of length appropriate for ease of installation; and
a plurality of transverse, flexible, hollow plastic tubes attached along the width of the strip of plastic, spaced about every three feet and fillable with sand, cement, aggregate or other material adequate to hold the plastic strip in close proximity to the contour of the ditch.

11. A weed suppression means in accordance with claim 10 wherein the specific gravity of the plastic strip is greater than 1.
